(19) United States
(12) Patent Application Publication
(10) Pub. No.: US 2008/0115189 A1
(43) Pub. Date: May 15, 2008

(54) TV-centric system

(76) Inventor: Stephane Lejeune, San Diego, CA (US)

Correspondence Address: ROGITZ & ASSOCIATES, 750 B STREET, SUITE 3120, SAN DIEGO, CA, 92101, US

(21) Appl. No.: 11/595,771

(22) Filed: Nov. 10, 2006

(51) Int. Cl. H04N 7/16

(52) U.S. Cl. 725/141

(57) ABSTRACT

A network includes a server such as a TV and one or more client components. The server and client component automatically detect each other and automatically determine that the client component possesses at least one unconsummated capability. Software necessary for the client component to execute the capability is downloaded from the Internet.

### FIELD OF THE INVENTION

The present invention relates generally to TV-centric home entertainments systems.

### BACKGROUND OF THE INVENTION

As home networks proliferate and improve, they grow more complex with the addition of new devices. For example, a home network may be centered on a TV that can receive information not only from a cable modem and satellite dish but also from digital video recorders (DVRs), digital video disk (DVD) players, and even an in-home computer and the Internet. As understood herein, even technical users can be daunted by visualizing and understanding network participation and connectivity, let alone undertake initial connections of new devices to the networks typically accompanied by authentication and handshaking protocols, updating devices with new software, etc.

Furthermore, adding to the complexity is the fact that some network devices may have capabilities a user might desire but be unable to use, owing to the capabilities being unconsummated by a lack of necessary software. As understood herein, a user may not know that a capability can be added if only she would add the necessary software to the device. One such capability may be collaboration between a device and server.

One reason the lack of software can arise is that all the software needed for all possible server/client collaborations is not included in the client/server device at manufacturing time because of practicality reasons. For example, the devices that will be included in any given home network typically are not known at manufacturing time and too many combinations exist for all the software to be included at manufacturing time. Further, network devices may not have sufficient memory to contain all possible software variations and it is only when the home network is assembled that the needed software can be identified and downloaded. As an example, too many mobile phones variations exist for a server such as a TV to contain the needed software to work with each one of them.

Yet another reason for the problem noted above is that the software of the different devices that make up the home network evolves and typically new functionalities are added over time that will be exposed to the network. With these recognitions in mind, the invention herein is provided.

### SUMMARY OF THE INVENTION

Accordingly, the present invention provides for a home network device or a TV-centric server to identify new collaboration possibilities on the network, so that requisite software can be downloaded to the device to take full advantage of these new additions the network.

As an example, a TV identifies that a new software upgrade is available to provide caller ID on a mobile phone and that a software upgrade exists for the TV to display caller ID. In this example, the TV then upgrades one or both of itself and the mobile phone so that the two can collaborate to display caller ID on the TV for call coming in on the mobile phone. Past efforts to enable such collaboration have typically focussed on standardizing the client device, rather than adapting a client device on the fly to add necessary or available capabilities.

Accordingly, a system includes a TV with TV processor and one or more client components communicating with the TV processor. A determination processor (e.g., the TV processor, or the client component, or a third device) automatically determines whether the client component has a capability but not software necessary to use the capability, and if so, the determination processor accesses the Internet to obtain the software and send the software to an appropriate component, e.g., to the client device or to the TV as appropriate.

One non-limiting example of the system is implemented by a client component that is a telephone and software that is caller ID software. More generally, the software can enable collaboration between the client component and the TV, so that, for example, the telephone can send caller ID information to the TV to display the caller ID information on a TV display.

In another aspect, a system has a wireless telephone, a TV with TV processor, and an Internet server that receives from the TV a request for software executable by the telephone. In response, the server downloads the software for execution by the telephone.

In yet another aspect, a server is provided on a network as is a client component. The server and client component automatically detect each other and automatically determine that the client component possesses at least one unconsummated capability. A determination processor causes software necessary for the client component to execute the capability to be downloaded to an appropriate component.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting TV-centric system in accordance with the invention; and

FIG. 2 is a flow chart of non-limiting logic that can be undertaken by the TV or other processor.

### DETAILED DESCRIPTION OF THE PREFERRED EMBODIMENT

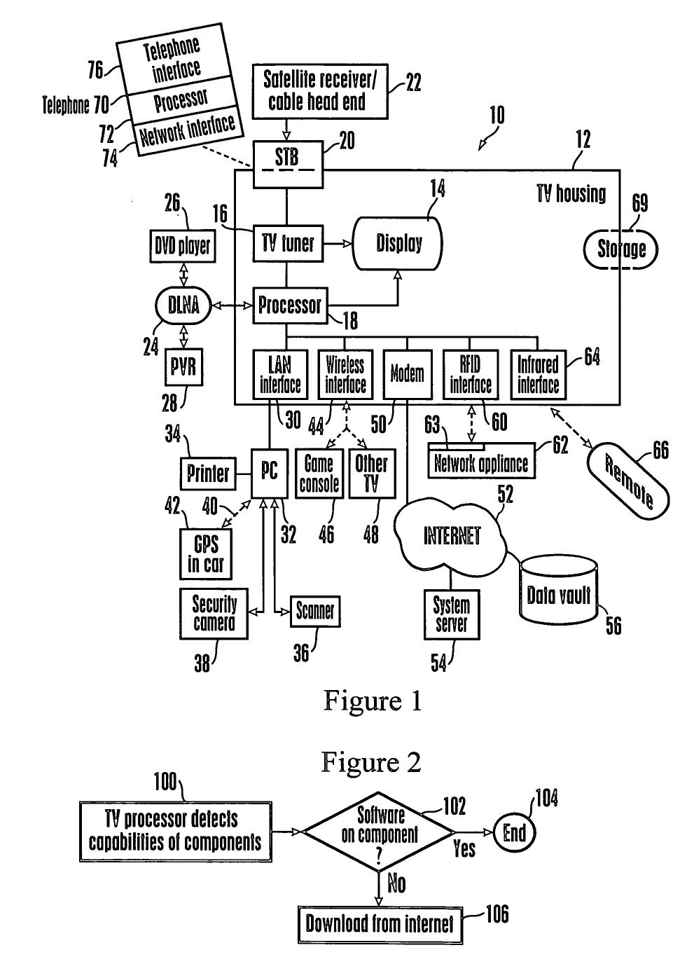

Referring initially to FIG. 1, a system is shown, generally designated 10, which includes a TV housing 12 holding TV components including a TV display 14, a TV tuner 16, and a TV processor 18. The TV tuner 16 may receive input from a set-top box (STB) 20 that, as indicated in FIG. 1, can be part of the housing 12 or alternatively can be in a housing separate from the housing 12. In any case, the STB 20 receives TV signals from one or more sources 22 such as but not limited to satellite receivers, cable system head ends, broadcast receiver antennae, etc. Depending on the nature of the signal, it may be sent directly to the display 14 from the tuner 16 or sent first through the processor 18 for subsequent display.

The non-limiting embodiment shown in FIG. 1 illustrates that the present TV can be connected to a plurality of external systems and networks, it being understood that in some implementations not all the components shown in FIG. 1 need be used. In essence FIG. 1 shows a comprehensive TV-centric system for completeness.

In one embodiment, the TV processor 18 may communicate with a digital living network association (DLNA) system 24. Also connected to the DLNA system 24 can be various components including but not limited to a disk player such as a DVD player 26 or Blu-Ray disk player and a personal video recorder (PVR) 28. Information including multimedia streams such as TV programs and movies can be exchanged between the TV processor 18 and the DVD player 26 and PVR 28 in accordance with DLNA principles known in the art.

A local areanetwork (LAN) interface 30 may be provided in the TV housing 12 and connected to the TV processor 18, so that the TV processor 18 can communicate with components on a LAN, implemented in some embodiments as an Ethernet. These components may include a personal computer 32 or other computer, and the computer 32 can communicate with computer network peripheral equipment such as but not limited to a printer 34, a scanner 36, and a security camera 38. All or parts of the computer network may overlap with the various networks with which the TV processor 18 communicates as discussed more fully below.

In addition to Ethernet links, the LAN may include one or more wireless links 40, so that the PC 32 (and, hence, the TV processor 18) may communicate with wireless components such as a vehicle-mounted global position satellite (GPS) receiver 42. Without limitation, the wireless link 40, like other wireless links herein, may be, e.g., an 802.11 link, a Wi-Fi link, a Bluetooth link, an IR link, an ultrasonic link, etc.

In some implementations, a pre-existing computer LAN might exist in the form of twisted pair wiring, coaxial wiring, etc. in a house, and it might be desired to use the pre-existing LAN for the TV components to establish a shared network. In such a case, the physical media is shared between the PC 32 and TV processor 18 with associated components. In one embodiment, the TV components can use a first protocol such as a proprietary protocol while the PC 32 and associated peripherals can use a different, second protocol, so that communication interference is avoided. Alternatively, if a common protocol is used, undesirable devices from the TV standpoint (such as, e.g., the printer 34 and scanner 36) can be removed from the TV network so that, for example, they do not appear on the below-described TV network maps.

When the same protocol is used between the TV processor 18 and the PC 32, the TV processor 18 can be given arbiter rights to manage bandwidth for audio/video data transmissions in the network, and the PC 32 can be given arbiter rights to manage bandwidth for non-audio/video data transmissions. Also, the TV processor 18 may “see” the PC 32 in the TV network but this does not mean that the PC 32 necessarily recognizes the TV components to be part of its network.

Apart from the wireless link 40 of the LAN with which the TV processor 18 may communicate, a wireless communication interface 44 may be in the TV housing 12 and may communicate with the TV processor 18 as shown. The wireless communication interface may wirelessly communicate with various components such as but not limited to a video game console 46, such as a Sony Playstation®, and another TV 48 that might be located in, e.g., another room of the same dwelling.

The processor 18 may also communicate with a computer modem 50 in the TV housing 12 as shown. The modem 50 may be connected to the Internet 52, so that the TV processor 18 can communicate with a web-based system server 54 and a web-based data vault 56.

In addition to the wireless communication interface 44 and the modem 50, the TV processor 18 may communicate with a radiofrequency identifier (RFID) interface 60 in the housing 12 or attached thereto using, e.g., a uniform serial bus (USB) cable, to facilitate communication in accordance with RFID principles known in the art between the TV processor 18 and an RFID-enabled network appliance 62 having an RFID device 63 mounted on it or connected to it. Furthermore, the TV processor 18 can, through an infrared interface 64, receive user commands from a remote control device 66 that transmits IR signals, it being understood that the remote control device 66 may alternately use RF, in which case the interface 64 would be an RF interface.

FIG. 1 also shows that the TV can have a data storage 69. The storage 69 may be flash or ROM or RAM in the TV and/or it may be a removable memory device such as a Sony Memory Stick®. As yet another example of a network component, a wireless telephone 70 with processor 72 can be incorporated into the network to communicate with the other components over the network through a home network interface 74. The telephone 70 can of course also have a wireless telephony interface 76 for placing voice and data calls using CDMA, GSM, TDMA, etc.

Now referring to FIG. 2, the TV processor 18 can ensure component capability maximization by detecting capabilities of components at block 100 in FIG. 2 and then determining, at decision diamond 102, whether appropriate software exists on the component to fully exploit the component's capability. If so, the logic ends at state 104, but otherwise necessary software is automatically downloaded from the Internet by the TV processor 18 and transmitted through one or more of the links shown in FIG. 1 to the relevant component.

To illustrate, suppose the TV processor 18 determines that the phone 70 in FIG. 1 has caller ID service capability but not the actual software to use the service, and/or that the phone 70 lacks the software to share the service with the TV (which could otherwise display the telephone numbers from incoming telephone call sources). In this case, the TV processor 18 can access the Internet to download the necessary utility to the phone to enable the caller ID service/collaboration service. This is but one non-limiting example of the TV processor 18 determining that a capability exists on a TV network component but not the necessary software, and obtaining the necessary software from the Internet on behalf of the component.

Thus, in one implementation a component such as a client device telephone 70 and a server such as a TV processor 18 might detect each other's presence but be unable to collaborate in, e.g., the display of incoming telephone call numbers owing to the lack of software on the client device. In such a case, the TV processor 18 detects the type of phone and might access a database correlating phone type to a list of capabilities, see that the phone possesses caller ID collaboration capability, and then access the server 54 to download the missing software into the phone 70 either over the home network or directly from the server 54 to the phone 70 over the wireless telephony system.

It is to be understood that the logic of FIG. 2 may be performed by the TV processor 18 as described, or by the phone processor 72, or by a third network component that detects both the TV and phone, e.g., by the network appliance 62. It is to be further understood that in situations wherein the necessary software for added client device (e.g., telephone 70) capability requires storage on a system server (e.g., the TV), then the software is loaded onto the server.

In any case, the above process preferably is automatic and transparent to the user, with the following exception. Once device and capability discovery has been undertaken and new, unconsummated capabilities discovered (i.e., along the “no” branch stemming from decision diamond 102) and prior to downloading the software at block 106, the user may be presented with a prompt informing the user of the new capability and asking the user to enter approval of adding the capability. In this way, the user need only respond “yes” to add the capability, while retaining the option to respond “no” if, for example, the new capability has a cost that the user does not wish to bear.

While the particular TV-CENTRIC SYSTEM is herein shown and described in detail, it is to be understood that the subject matter which is encompassed by the present invention is limited only by the claims.

What is claimed is:

1. A system, comprising:
at least one TV having a TV processor;
at least one client component communicating with the TV processor;
wherein a determination processor automatically determines whether the client component has a capability but not software necessary to use the capability, and if so, the determination processor accesses the Internet to obtain the software and send the software to an appropriate component.

2. The system of claim 1, wherein the determination processor is established by the TV processor.

3. The system of claim 1, wherein the determination processor is established by the client component.

4. The system of claim 1, wherein the determination processor is established by neither the TV processor nor the client component.

5. The system of claim 1, wherein the appropriate component to which the software is sent is the client component.

6. The system of claim 1, wherein the appropriate component to which the software is sent is the TV.

7. The system of claim 1, wherein the client component is a telephone and the software is caller ID software.

8. The system of claim 1, wherein the software enables collaboration between the client component and the TV.

9. The system of claim 1, wherein the client component is a telephone and the software enables the telephone to send caller ID information to the TV to display the caller ID information on a TV display.

10. A system comprising:
at least one wireless telephone;
at least one TV with TV processor; and
at least one Internet server receiving from the TV a request for software executable by the telephone and in response downloading the software for execution by the telephone.

11. The system of claim 10, wherein the software is caller ID software.

12. The system of claim 10, wherein the software enables collaboration between the telephone and the TV.

13. The system of claim 10, wherein the software enables the telephone to send caller ID information to the TV to display the caller ID information on a TV display.

14. A system comprising:
a network;
a server on the network;
at least one client component on the network, the server and client component automatically detecting each other and automatically determining that the client component possesses at least one unconsummated capability, a determination processor causing software necessary for the client component to execute the capability to be downloaded to an appropriate component.

15. The system of claim 14, wherein the determination processor is established by a TV processor.

16. The system of claim 14, wherein the determination processor is established by the client component.

17. The system of claim 14, wherein the determination processor is established by neither the server nor the client component.

18. The system of claim 14, wherein the appropriate component to which the software is sent is the client component or a TV.

19. The system of claim 14, wherein the client component is a telephone and the software is caller ID software.

20. The system of claim 14, wherein the software enables collaboration between the client component and the server.
